(19) United States
(12) Patent Application Publication
(10) Pub. No.: US 2001/0020951 A1
(43) Pub. Date: Sep. 13, 2001

(54) Apparatus and method for transferring video data

(76) Inventor: Seiki Onagawa, Tokyo (JP)

Correspondence Address: SUGHRUE, MION, ZINN, MACPEAK & SEAS, 2100 Pennsylvania Avenue, N.W., Washington, DC, 20037, US

(21) Appl. No.: 09/799,555

(22) Filed: Mar. 7, 2001

(30) Foreign Application Priority Data
Mar. 10, 2000 (JP) 2000-067806

(51) Int. Cl. G09G 5/00

(52) U.S. Cl. 345/696

(57) ABSTRACT

Overlay display can be performed correctly even in a heavy load state regarding video data amount on a general purpose bus. The video data transfer apparatus of the present invention comprises an FIFO memory for video data and outputting a nearly-full signal when held data become close to full and a transfer control section stopping an output enable signal so as to stop output from the FIFO memory at the time of output of the nearly-full signal and restoring the output enable signal so as to perform control in which the video data on and after an output stop position are outputted from the FIFO memory when the same position as the output stop position appears in a frame on and after the frame of the output stop time when the nearly-full signal disappears.

### BACKGROUND OF THE INVENTION

1. Technical Field of the Invention

The present invention relates to a video data transfer apparatus and a transfer method for video data for performing an overlay display of an image on a display screen of a computer.

2. Description of the Prior Art

In a computer apparatus, a video data transfer apparatus has been conventionally employed for performing an overlay display of additional images which has already been displayed on its display screen.

FIG. 4 is a block diagram showing a configuration of a first conventional example, shows a schematically configuration of a computer apparatus in such a case when transfer of video data is performed for a display apparatus, and shows that a video data transfer apparatus 100, a graphics apparatus 200, a general purpose bus 300, a bus arbiter 400, a system memory 500, and a central processing unit (CPU) 600 are included.

The video data transfer apparatus 100 performs processing for transferring video data to the general purpose bus 300 to perform an overlay display. The graphics apparatus 200 performs processing for performing an image display on a screen of a not-shown monitor apparatus by using video data outputted via the general purpose bus 300. The general purpose bus 300 transmits the data which are outputted/received among the respective sections inside the computer apparatus. The bus arbiter 400 performs arbitration of a bus connection request between the system memory 500 or the CPU 600 and each section inside the computer apparatus to manage data transfer of the general purpose bus 300. The system memory 500 stores a program and data that the CPU 600 administers. The CPU 600 employs the program stored in the system memory 500 to control operations of the entire computer apparatus.

In this conventional example, the video data transfer apparatus 100 comprises a memory input/output section (I/F) 101, a frame buffer 102, and a general purpose bus I/F 103. The system memory 500 includes a video area 501.

The memory I/F 101 inputs inputted video data in the frame buffer 102 by a predetermined control procedure and outputs video data of the frame buffer 102 to the general purpose bus I/F 103. The frame buffer 102 performs writing (data write) of video data inputted from the memory I/F 101 for each frame and performs reading (data read) for each frame for the memory I/F 101 by the data written. The general purpose bus I/F 103 transfers the video data outputted from the memory I/F 102 to the general purpose bus 300 by the predetermined control procedure.

In the system memory 500, the video data transmitted/received by the general purpose bus 300 are temporarily held in the video area 501 according to the control of the CPU 600.

In the video data transfer apparatus shown in FIG. 4, when an overlay display of images is performed on a display screen of the computer, the video data transfer apparatus 100 transfers the video data to the video area 501 on the system memory 500 via the general purpose bus 300 and delivers the video data to the graphic apparatus 200, whereby the graphic apparatus 200 performs required image processing for the video data input to perform the overlay display of a new image on the image that has already been displayed on the display screen on a monitor which is not shown.

The video data transfer apparatus 100 has two frame buffers in order to deal with a change in a video data transfer rate based on a change in a transfer amount of data from another section on the general purpose bus. Further, the video data transfer apparatus 100 thins out unnecessary frames transmitted in the case where a band for transferring video data cannot be secured by alternately performing the data write and the data read, whereby video display without disturbance in an image can be performed.

FIG. 5 is a block diagram showing a configuration of a second conventional example, shows a schematically configuration of a computer apparatus of the time when transfer of video data is performed for a display apparatus, and shows that a video data transfer apparatus 100A, a graphics apparatus 200, a general purpose bus 300, a bus arbiter 400, a system memory 500, and a central processing unit (CPU) 600 are included.

In this conventional example, the video data transfer apparatus 100A comprises a general purpose bus I/F 103 and an FIFO (First In First Out) memory 104.

The capacity of FIFO memory 104 is smaller than one frame.

The conventional example shown in FIG. 5 has the small capacity or small step FIFO memory 104, in place of memory I/F and the frame buffer. Therefore, when a band for transferring video data cannot be secured on the general purpose bus 300, it is detected that an overflow occurs in the FIFO memory 104, and the CPU 600 allows the general purpose bus I/F 103 to stop video data transfer in order to thin out data so that the difference between the video data input rate and the video data output rate to the general purpose bus is absorbed. Thus, operations similar to the conventional example shown in FIG. 4 can be performed.

However, as shown in FIG. 4, in the form in which a frame buffer is contained in the video data transfer apparatus, there is a disadvantage that it is not avoidable that the circuit scale becomes large.

This is because a frame buffer for at least two frames is necessary to deal with a change in the video data transfer rate on the general purpose bus, employing the frame buffer as shown in FIG. 4.

Also, in the case of the format having an FIFO memory without employing a frame buffer in a video data transfer apparatus as shown in FIG. 5, there is a disadvantage that it is not avoidable that the circuit scale becomes large in order to avoid such an image disturbance when a band for video data transfer on a general purpose bus cannot be secured.

This is because since an overflow occurs in the FIFO memory when a band for video data transfer is not secured on a general purpose bus, video data is lost so that dislocation in display positions of each video datum on the video frame occurs, resulting in disturbance in an image. In order to prevent this, a skip control or the like for a transfer destination data address becomes necessary and thus a large scale circuit for such control has to be added newly.

The present invention was developed, considering the circumstances described above, and it is an object of the present invention to provide a video data transfer apparatus and a transfer method for video data by which it is not necessary to add a new circuit for video data transfer and which can be realized by a small scale circuit when an overlay display of an image is performed on a display screen of a computer by transferring video data to a graphics apparatus via a general purpose bus.

In order to solve the above-described problems, the video data transfer apparatus of the present invention comprises:

FIFO memory means performing processing of first-in first-out transfer for video data and outputting a nearly-full signal when held data become close to full; and

transfer control means stopping an output enable signal so as to stop output from the FIFO memory means at the time of output of the nearly-full signal and restoring the output enable signal so as to perform control in which the video data on and after the position of the output stop are outputted from the FIFO memory means when the same position as the output stop position appears in a frame on and after the frame of the output stop time when the nearly-full signal disappears.

The video data transfer apparatus of the present invention may further comprises DMA I/F means performing processing of DMA transfer for output data from the FIFO memory means in accordance with the output enable signal, characterized in that the DAM I/F means transfers output data of the FIFO memory means to a bus bridge means in accordance with a data request signal from the bus bridge means.

The video data transfer apparatus of the present invention may further comprises:

first counter means counting a pixel clock for each occurrence of a horizontal synchronizing signal;

horizontal position storing means storing a discrete value of the first counter means as a horizontal position of an image at the time of occurrence of an offset latch signal;

first comparison means generating a first coincidence signal when the discrete value of the first counter means and the stored value of the horizontal position storing means coincide with each other;

second counter means counting the horizontal synchronizing signal for each occurrence of a vertical synchronizing signal;

vertical position storing means storing a discrete value of the second counter means, as a vertical position of an image at the time of occurrence of an offset latch signal; and

second comparison means generating a second coincidence signal when the discrete value of the second counter means and the stored value of the vertical position storing means coincide with each other,

characterized in that the transfer control means generates the offset latch signal at the time of occurrence of the nearly-full signal and resumes the output of the output enable signal at the time of occurrence of the first coincidence signal and the second coincidence signal.

The video data transfer apparatus of the present invention further comprises: a dividing means dividing the pixel clock to generate a divided clock,

characterized in that the first counter means counts the divided clock for each occurrence of the horizontal synchronizing signal, the horizontal position storing means stores the discrete value of the first counter means as a horizontal position of an image at the time of occurrence of the offset latch signal, the first comparison means generates the first coincidence signal due to coincidence between the discrete value of the first counter means and the stored value of the horizontal position storing means.

The transfer method for video data of the present invention characterized in that in an FIFO memory, processing of first-in first-out transfer for video data is performed and a nearly-full signal is outputted when held data become close to full, and in a transfer control section, an output enable signal is stopped so that output from the FIFO memory is stopped at the time of output of the nearly-full signal and the output enable signal is restored so that control in which the video data on and after the position of the output stop in the FIFO memory are outputted is performed when the same position as the output stop position appears in a frame on and after the frame of the output stop time when the nearly-full signal disappears.

The transfer method for video data of the present invention may be characterized in that processing of DMA transfer is performed for output data from the FIFO memory in accordance with the output enable signal, and output data of the FIFO memory are transferred to the bus bridge in accordance with a data request signal from the bus bridge.

The transfer method for video data of the present invention may be characterized by:

generating an offset latch signal at the time of occurrence of the nearly-full signal;

counting a pixel clock for each occurrence of a horizontal synchronizing signal;

storing a discrete value of the pixel clock as a horizontal position of an image at the time of occurrence of the offset latch signal;

generating a first coincidence signal when the discrete value of the pixel clock and the stored value of the horizontal position coincide with each other;

counting the horizontal synchronizing signal for each occurrence of a vertical synchronizing signal;

storing a discrete value of the number of lines as a vertical position of an image at the time of occurrence of the offset latch signal; and

generating a second coincidence signal when the discrete value of the number of lines and the stored value of the vertical position coincide with each other so that the transfer control section performs control of resumption of output of the output enable signal in accordance with the occurrence of the first coincidence signal and the second coincidence signal.

The transfer method for video data of the present invention may be characterized by:

dividing the pixel clock to count the divided clock for each occurrence of the horizontal synchronizing signal by the divided clock;

storing a discrete value of the divided clock as a horizontal position of an image at the time of occurrence of the offset latch signal; and

generating the first coincidence signal by coincidence of the discrete value of the divided clock and the stored value of the horizontal position

The configuration of the present invention comprises FIFO memory means to perform processing of first-in first-out transfer for video data and output a nearly-full signal when held data become close to full and comprises transfer control means to stop an output enable signal at the time of output of the nearly-full signal so as to stop output from the FIFO memory means and restore the output enable signal so as to perform control in which the video data on and after the position of the output stop in the FIFO memory means are outputted when the same position as the output stop position appears in a frame on and after the frame of the output stop time when the nearly-full signal disappears.

Thus, when the amount of data on a general purpose bus on which video data are transferred goes to a heavy load state, since transfer of video data is stopped for a time at that time and transfer of video data is resumed from the same position at a frame on and after the next frame, dislocation in offset of video data on a video frame based on lack of data due to overflow of the FIFO memory means is prevented so that disturbance in an image can be prevented, and it can be prevented that the circuit scale becomes large since it is not necessary to add a new function for transferring video data to the general purpose bus bridge.

As described above, with the present invention, since transfer of video data is stopped for a time when the amount of transfer data on the general purpose bus on which transfer of video data is performed goes to a heavy load state and transfer of data is resumed from the video data of the same offset value in a frame on and after the next frame, dislocation in offset of video data on a video frame due to lack of data based on overflow of data in the FIFO memory in the video data transfer apparatus can be prevented, and thus overlay display without disturbance in an image can be performed.

Further, with the present invention, since a new function does not have to be added for video data transfer in the general purpose bus bridge, it is not necessary to newly provide large scale hardware for connection to the general purpose bus.

In the case where control of video data transfer stop is performed, employing a clock obtained by dividing a pixel clock by a predetermined division ratio, it is possible to minimize the number of bits of a circuit necessary for storing of an offset value in a horizontal line direction of video data of the time of transfer stop and for detecting appearance of the same offset value in a following frame, and thus the circuit scale can be reduced.

### BRIEF EXPLANATION OF THE DRAWINGS

FIG. 1 is a block diagram showing a configuration of a first embodiment of the present invention.

FIGS. 2A and 2B are illustrations for explaining transfer suspension and a transfer resumption of video data of the time of occurrence of a nearly-full signal.

FIG. 3 is a block diagram showing a configuration of a second embodiment of the present invention.

FIG. 4 is a block diagram showing a configuration of a conventional example.

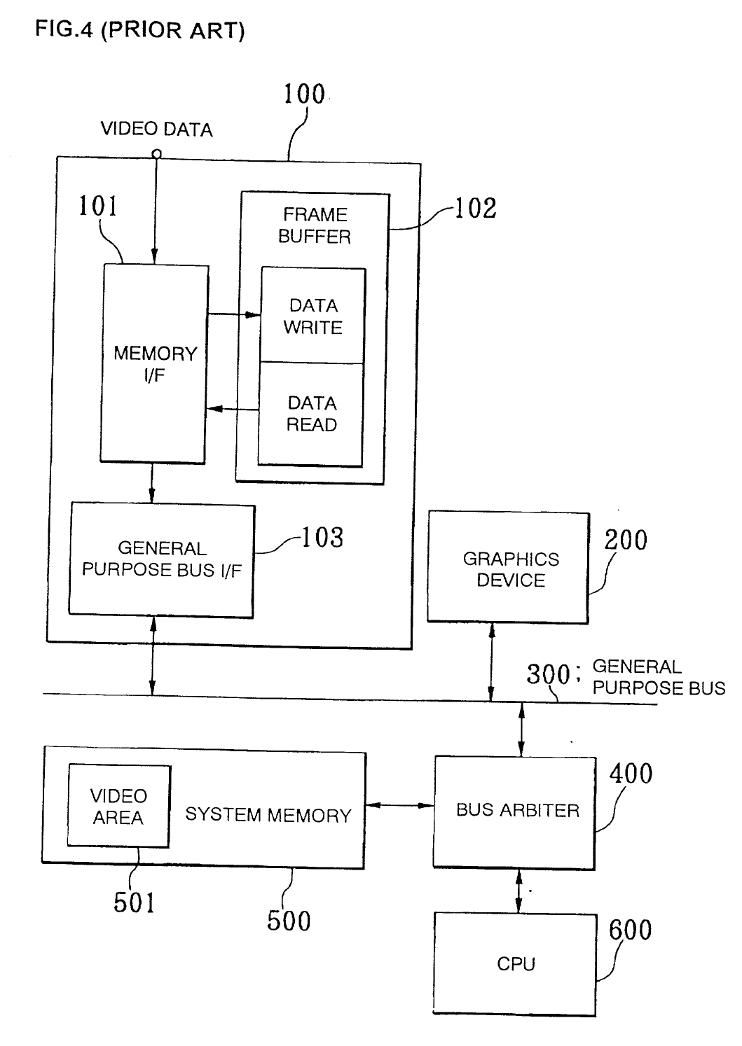

FIG. 5 is a block diagram showing a configuration of another conventional example.

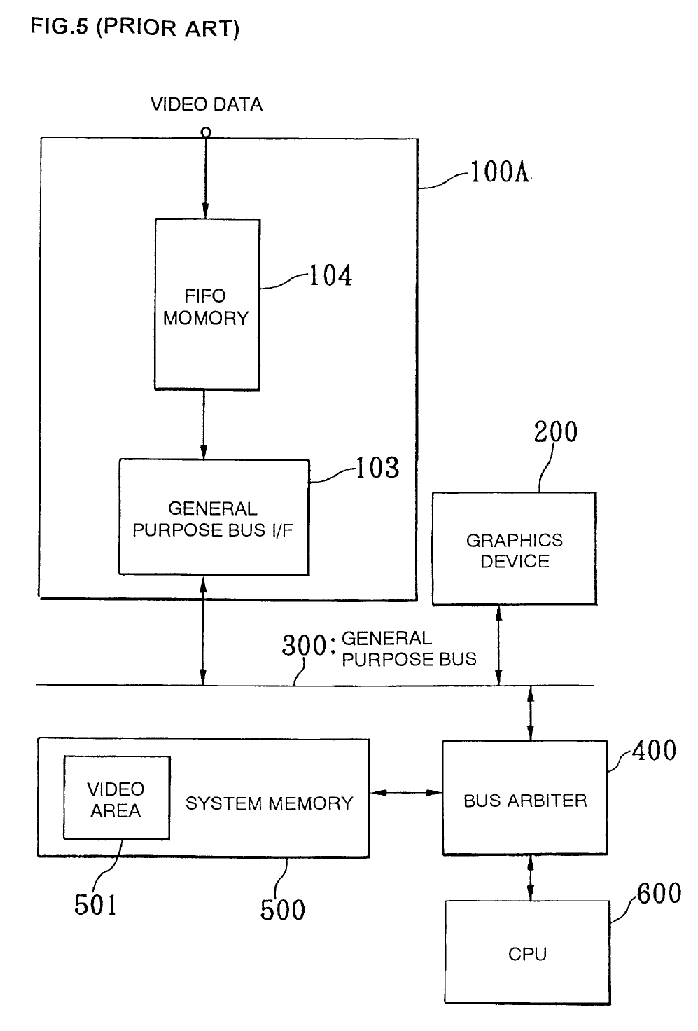

### PREFERRED EMBODIMENT OF THE INVENTION

Embodiments of the present invention will be explained below, referring to drawings. Explanation will be concretely given, employing embodiments.

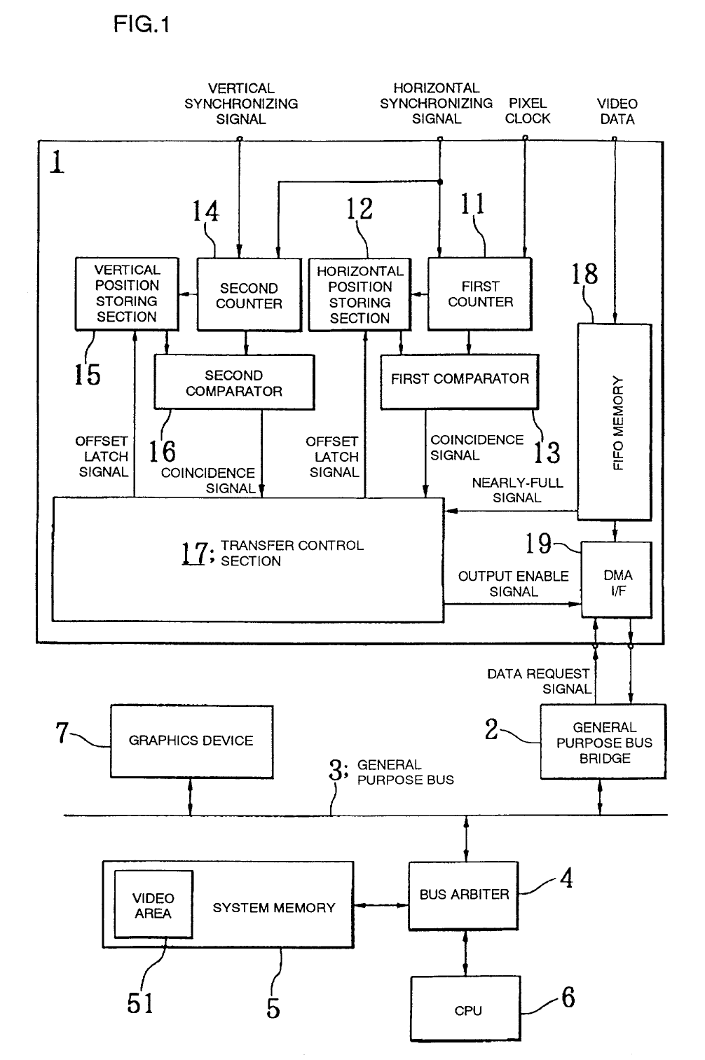

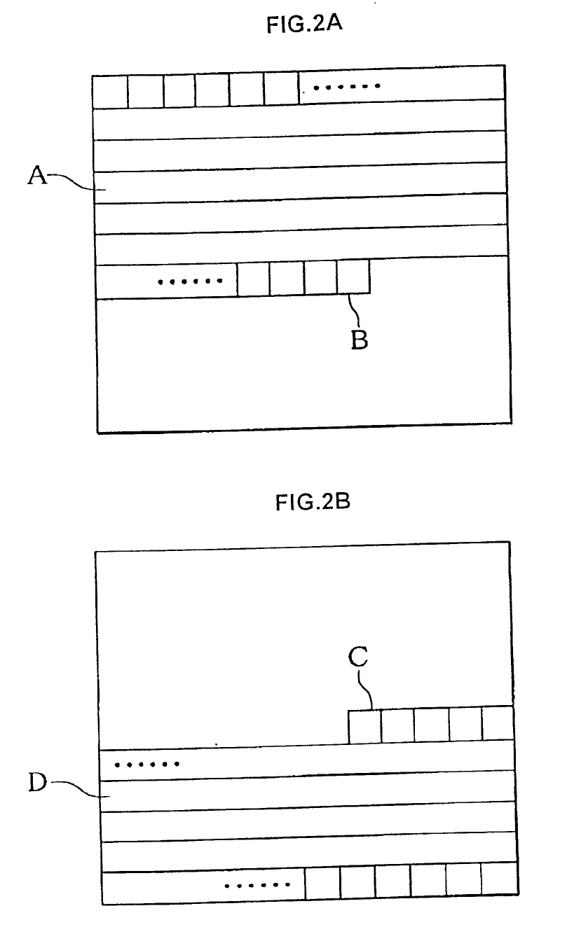

FIG. 1 is a block diagram showing a configuration of a first embodiment of the present invention, and FIG. 2 is a diagram for explaining a transfer suspension and a transfer resumption of video data at the time of occurrence of a nearly-full signal.

FIG. 1 shows a schematically configuration of a computer apparatus at the time when transfer of video data is performed for a display apparatus, and shows that a video data transfer apparatus 1, a general purpose bus bridge 2, a general purpose bus 3, a bus arbiter 4, a system memory 5, and a CPU 6, and a graphics apparatus 7 are included.

The video data transfer apparatus 1 performs processing for transferring input video data to be overlay displayed to the general purpose bus bridge 2. The general purpose bus bridge 2 connects the video data outputted from the video data transfer apparatus 1 to the general purpose bus 3 in accordance with a predetermined access procedure between the general purpose bus. The general purpose bus 3 is connected with respective sections inside the computer apparatus to transmit the data which are outputted/received among the respective sections bidirectionally and is a general purpose one.

The bus arbiter 4 performs arbitration for a bus connection request with the system memory 5 or the CPU 6 and each section inside the computer apparatus to manage data transfer of the general purpose bus 3. The system memory 5 stores a program and data that the CPU 6 administers. The CPU 6 employs the program stored in a memory which is not shown to control operations of the entire computer apparatus. The graphics apparatus 7 performs processing for performing image display on the screen of a monitor apparatus which is not shown by the video data inputted via the general purpose bus 3.

The video data transfer apparatus 1 of this example is schematically composed of a first counter 11, a horizontal position storing section 12, a first comparator 13, a second counter 14, a vertical position storing section 15, a second comparator 16, a transfer control section 17, an FIFO memory 18, and a DMA (Direct Memory Access) I/F 19 as shown in FIG. 1.

The first counter 11 starts counting a pixel clock of a video signal from a horizontal synchronizing signal to count the number of video data which have already been transferred in one line in the horizontal direction. The horizontal position storing section 12 temporarily stores a discrete value of the first counter 11 in accordance with an offset latch signal from the transfer control section 17. The first comparator 13 compares the discrete value of the first counter 11 and the value stored in the horizontal position storing section 12 and, at the time of coincidence, outputs a coincidence signal showing its state.

The second counter 14 starts counting the horizontal synchronizing signal from a vertical synchronizing signal to count the number of horizontal lines which have already been transferred in an image of one frame. The vertical position storing section 15 temporarily stores a discrete value of the second counter 14 in accordance with the offset latch signal from the transfer control section 17. The second comparator 16 compares the discrete value of the second counter 14 and the value stored in the vertical position storing section 15 and, at the time of coincidence, outputs a coincidence signal showing its state.

The transfer control section 17, when not receiving the nearly-full signal from the FIFO memory 18, outputs an output enable signal to the DMA I/F 19, synchronizing the pixel clock, and when receiving the nearly-full signal from the FIFO memory 18, outputs an offset latch signal for latching the offset value corresponding to the number of pixels from the start position in video data of one line to the horizontal position storing section 12, and outputs the offset latch signal for latching the offset value corresponding to the number of lines from the start position in video data of one frame to the vertical position storing section 15 and stops the output enable signal for the DMA I/F 19.

The FIFO memory 18 sequentially outputs the inputted video data to the DMA I/F 19 in accordance with the output enable signal to absorb the time difference between the timing of video data input and the timing of data output to the general purpose bus bridge 2 when the amount of data stored is small, and generates the nearly-full signal to output it to the transfer control section 17 and stop the output of data to the DMA I/F 19 in accordance with the stop of the output enable signal from the transfer control section 17 when the amount of data stored is close to a state of full. The number of steps of the FIFO memory 18 is decided by the input rate of video data including a blanking time of an image and a maximum data transfer capability that is determined by a processing amount for each access in the general purpose bus bridge 2.

The DMA I/F 19, when receiving the output enable signal from the transfer control section 17, outputs the video data outputted from the FIFO memory 18 to the general purpose bus bridge 2 directly by direct memory access in accordance with a data request signal without requiring participation of the CPU 6.

In general, a plurality of apparatuss are connected to the same general purpose bus inside the computer apparatus to mutually transmit/receive data via the general purpose bus, and the amount of data transfer on the general purpose bus is constantly fluctuated in accordance with operations of the respective apparatuss. When the overlay display of an image on the display screen of the computer apparatus is performed, video data are transferred to a memory area that the CPU or the graphics apparatus manages via the general purpose bus inside the computer apparatus.

In the video data transfer apparatus 1 of the present example, employed is the general purpose bus bridge 2 that is designed in advance in such a manner that DMA transfer by which video data are transferred directly to the system memory 5 without going through the CPU 6 can be utilized as a means transferring video data via the general purpose bus 3.

Generally, video data are transferred at a fixed rate except a horizontal synchronizing signal period and a vertical synchronizing signal period. Thus, it is necessary that a band at least in which video data can be transferred, even taking into account the horizontal synchronizing signal period and the vertical synchronizing signal period, is constantly secured on the general purpose bus. However, in reality, when another apparatus connected to the same general purpose bus in the computer is operated, there is a case in which a state wherein the band at least in which video data can be transferred is not secured occurs.

In the case where the amount of data transfer on the general purpose bus 3 has leeway and a transfer rate for data transfer by the general purpose bus bridge 2 is fully secured, video data inputted to the video data transfer apparatus 1 are outputted from the FIFO 18 in accordance with the output enable signal from the transfer control section 18, video data are transferred between the DMA I/F 19 and the general purpose bus bridge 2, taking timing of inputting and outputting by the FIFO 18, and video data are transferred to the video area 51 on the system memory 5 that the CPU 6 secures at the time of starting video data transfer by the general purpose bus bridge 2. At this time, the first counter 11 and the second counter 14 count the number of video data which have already been transferred in one line in the horizontal direction and the number of horizontal lines which have already been transferred in an image of one frame, respectively.

In the case where the amount of data transfer on the general purpose bus 3 goes to a heavy load state so that a band for transferring video data by the general purpose bus bridge 2 is not fully secured, since the video data inputted to the video data transfer apparatus 1 are accumulated in the FIFO memory 18 so that the inside of the FIFO memory 18 goes to a state close to overflow, the nearly-full signal is outputted from the FIFO memory 18.

Since the transfer control section 17 generates the offset latch signal when receiving the nearly-full signal from the FIFO memory 18, the transfer control section 17 stores the discrete value of the first counter 11 which shows the offset value from the start position of one line of video data in the horizontal position storing section 12 and stores the discrete value of the second counter 14 which shows the offset value from the start position of one frame of video data in the vertical position storing section 15 of the time when the FIFO memory 18 goes to a state close to overflow. The transfer control section 17, when receiving the nearly-full signal from the FIFO memory 18, stops the output enable signal to control the DMA I/F 19 so that the DMA I/F 19 stops transferring video data between the general purpose bus bridge 2.

Each of the whole of blocks in FIGS. 2A and 2B shows video data of one frame, and each small block shows video data of one pixel.

The video data transfer apparatus 1, when receiving the nearly-full signal showing that the FIFO memory 18 is in a state close to overflow during the time of transfer of video data of one frame, stops the output enable signal to stop transfer of video data from the pixel on and after the position shown by B as shown by A in FIG. 2 A.

In the case where, in the transfer stop state of video data, the transfer control section 17 detects that the coincidence signal is again generated at the same position as that where the transfer of video data is stopped last time at the position of C in FIG. 2 B in the video frame next to the video frame where the transfer of video data is stopped by monitoring the coincidence signal from the first comparator and the second comparator 16 and the nearly-full signal is not generated from the FIFO 18, that is, the state of the FIFO 18 is not that close to overflow, the transfer control section 17 generates the output enable signal to resume transfer of video data from the pixel on and after the position shown by C to control the DMA I/F 19 so that transfer of video data is performed as shown by D.

As described above, with the video data transfer apparatus of the present embodiment, in the case where the amount of transfer data on the general purpose bus goes to a heavy load state when video data are transferred via the general purpose bus, the offset value of the video data of that time is stored, and transfer of video data is stopped for a time so that transfer of video data is resumed from the video data of the same offset value in the frame on and after the next frame. Thus, in the FIFO memory inside the video data transfer apparatus, overflow which does not fill one frame does not occur, and dislocation in offset of video data on a video frame due to lack of data can be prevented, whereby overlay display without disturbance in an image can be performed.

The video data transfer apparatus of the present embodiment allows video data to be transferred, employing a function of the general purpose bus bridge as it is, and thus it is not necessary to add a new function for video data transfer to the general purpose bus bridge. Thus, for example, a commercially available general purpose bus can be utilized, and it is not necessary to newly provide large scale hardware in order to connect to the general purpose bus.

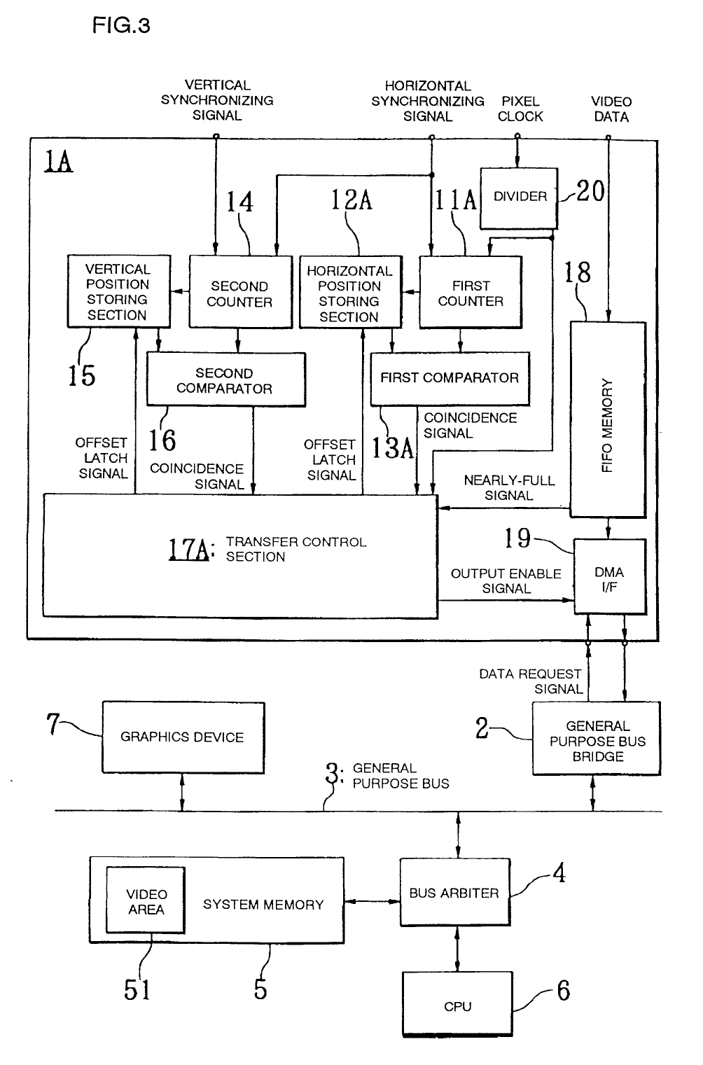

FIG. 3 is a block diagram showing a configuration of a second embodiment of the present invention.

In this example, since the configuration of the computer apparatus for transferring vide data to a display apparatus is similar to that of the case of the first embodiment shown in FIG. 1, detail explanation regarding this will be omitted.

A video data transfer apparatus 1A of the present embodiment is schematically composed of a first counter 11A, a horizontal position storing section 12A, a first comparator 13A, a second counter 14, a vertical position storing section 15, a second comparator 16, a transfer control section 17A, an FIFO memory 18, and a DMA I/F 19, and a divider 20 as shown in FIG. 3.

The first counter 11A starts counting a divided clock from the divider 20 from a horizontal synchronizing signal to count the number of video data which have already been transferred in one line in the horizontal direction for each of plural bits corresponding to the division ratio of the divider 20. The horizontal position storing section 12A temporarily stores a discrete value of the first counter 11A in accordance with an offset latch signal from the transfer control section 17A. The first comparator 13A compares the discrete value of the first counter 11A and the value stored in the horizontal position storing section 12A and, at the time of coincidence, outputs a coincidence signal showing its state.

The second counter 14 starts counting the horizontal synchronizing signal from a vertical synchronizing signal to count the number of horizontal lines which have already been transferred in an image of one frame. The vertical position storing section 15 temporarily stores a discrete value of the second counter 14 in accordance with the offset latch signal from the transfer control section 17. The second comparator 16 compares the discrete value of the second counter 14 and the value stored in the vertical position storing section 15 and, at the time of coincidence, outputs a coincidence signal showing its state.

The transfer control section 17A, when not receiving the nearly-full signal from the FIFO memory 18, outputs an output enable signal to the DMA I/F 17, synchronizing the divided clock from the divider 20, and when receiving the nearly-full signal from the FIFO memory 18, outputs an offset latch signal for latching the offset value corresponding to the number of pixel blocks for each bit number corresponding to the division ratio in the divider 20 from the start position in video data of one line to the horizontal position storing section 12A, and outputs the offset latch signal for latching the offset value corresponding to the number of lines from the start position in video data of one frame to the vertical position storing section 15 and stops the output enable signal for the DMA I/F 19.

The FIFO memory 18 sequentially outputs the video data inputted to the DMA I/F 19 in accordance with the output enable signal to absorb the time difference between the timing of video data input and the timing of data output to the general purpose bus bridge 2 when the amount of data stored is small, and generates the nearly-full signal to output it to the transfer control section 17A and stop the output of data to the DMA I/F 19 in accordance with the stop of the output enable signal from the transfer control section 17A when the amount of data stored is close to a state of full.

The DMA I/F 19, when receiving the output enable signal from the transfer control section 17A, outputs the video data outputted from the FIFO memory 18 to the general purpose bus bridge 2 by direct memory access in accordance with a data request signal. The divider 20 divides the pixel clock by a predetermined division ratio to output the divided clock.

In the second embodiment, the divider 20 is provided between the pixel clock input and the first counter 11A to divide the pixel clock by the predetermined division ratio. The first counter 11A counts the number of video data for the horizontal direction, employing that divided pixel clock, and the horizontal position storing section 12A stores count result of the first counter 11A. The first comparator 13A compares the count result of the first counter 11A and stored result of the horizontal position storing section 12A to output a coincidence signal. The transfer control section 17A stops the output enable signal by that coincidence signal to perform control of data transfer stop for the DMA I/F 19.

Although stop control of video data transfer is performed by the nearly-full signal generated by monitoring for a state close to overflow of the FIFO memory 18 in the video data transfer apparatus of the present invention, even immediately after the nearly-full signal is generated from the FIFO memory 18, in reality, it is possible to write video data of several bytes for the FIFO memory 18. Thus, with respect to the control of the video data transfer stop for the DMA I/F 19 by the counting of the first counter 11 of the case of the first embodiment, it is possible to reduce accuracy for several bits.

In the present example, since the control of the video data transfer stop is performed, employing the clock obtained by dividing the pixel clock by the predetermined division ratio, an advantage is produced wherein the numbers of bits of the first counter 11A, the horizontal position storing section 12A, and the first comparison section 13A can be made smaller and thus the circuit scale can be reduced, compared with the case of the first embodiment, in addition to the advantageous effects of the case of the first embodiment.

Although two embodiments of the present invention are explained in detail, referring to the drawings, in the above, concrete configurations are not limited to these embodiments, and modifications or the like in design in the scope from which the gist of the present invention is not departing are embraced in the present invention. For example, video data may be an monochromatic image or a color image made of a RGB signal. Video data are not limited to a static image and may be a dynamic image. Further, video data are not limited to a one dimensional image and may be a three dimensional image.

What is claimed is:

1. A video data transfer apparatus which comprises:
an FIFO memory for transferring video data and for outputting a nearly-full signal when said video data occupy almost entire capacity of said FIFO memory; and
transfer control means for stopping an output enable signal so as to instruct an output stoppage of said video data from said FIFO memory at the timing when said nearly-full signal is outputted, and for restoring said output enable signal so as to output said video data after said output stoppage, when the same position as the output stoppage position appears in a frame, after said nearly-full signal disappears.

2. The video data transfer apparatus according to claim 1, which further includes DMA I/F means for transferring said video data from said FIFO memory in accordance with said output enable signal; and
a bus bridge for requesting said DMA/IF to transfer said video data to said bus bridge.

3. The video data transfer apparatus according to claim 1, which further comprises:
a first counter for counting a pixel clock for each horizontal synchronizing signal;
horizontal position storing means for storing a counted value from said first counter as a horizontal image position at the timing of an offset latch signal;
first comparison means for generating a first coincidence signal when said counter value from said first counter coincides with the stored value of the horizontal position storing means;
a second counter for counting said horizontal synchronizing signal per vertical synchronizing signal;
vertical position storing means for storing a counted value from said second counter as a vertical image position at the timing of occurrence of said offset latch signal; and
second comparison means for generating a second coincidence signal when said counted value from said second counter coincides with the stored value of said vertical position storing means,
wherein said transfer control means generates said offset latch signal at the timing of the nearly-full signal and resumes the output of said output enable signal at the timing of occurrence of said first coincidence signal and said second coincidence signal.

4. The video data transfer apparatus according to claim 3, which includes a dividing means for generating a divided clock of said pixel clock,
wherein:
said first counter counts said divided clock for each horizontal synchronizing signal;
said horizontal position storing means stores said counted value from said first counter as said horizontal image position at the timing of said offset latch signal;
said first comparison means generates said first coincidence signal on the basis of a coincidence between said counted value from said first counter and said stored value from said horizontal position storing means.

5. A video data transfer method which comprises the steps of:
transferring video data from an FIFO memory;
outputting a nearly-full signal when said video data occupy almost entire capacity of said FIFO memory;
stopping an output enable signal so as to instruct an output stoppage of said video data from said FIFO memory at the timing when said nearly-full signal is outputted; and
restoring said output enable signal so as to output said video data after said output stoppage, when the same position as the output stoppage position appears in a frame, after said nearly-full signal disappears.

6. The video data transfer method according to claim 5, which further includes the steps of:
transferring said video data from an FIFO memory through a DMA/IF in accordance with said output enable signal; and
transferring said video data to a bus bridge from said DMA/IF in accordance with a request from said bus bridge.

7. The video data transfer method according to claim 5, which further comprises the steps of:
counting a pixel clock for each horizontal synchronizing signal by using a first counter;
storing a counted value from said first counter as a horizontal image position at the timing of an offset latch signal;
generating a first coincidence signal when said counter value from said first counter coincides with the stored value of the horizontal position storing means;
counting said horizontal synchronizing signal per vertical synchronizing signal by using a second counter;
storing a counted value from said second counter as a vertical image position at the timing of occurrence of said offset latch signal; and
generating a second coincidence signal when said counted value from said second counter coincides with the stored value of said vertical position storing means; and
resuming the output of said output enable signal at the timing of occurrence of said first coincidence signal and said second coincidence signal.

8. The video data transfer method according to claim 7, which further comprises the steps of:
generating a divided clock of said pixel clock;
counting said divided clock for each horizontal synchronizing signal by using a first counter;
storing said counted value from said first counter as said horizontal image position at the timing of said offset latch signal; and
generating said first coincidence signal on the basis of a coincidence between said counted value from said first counter and said stored value of horizontal image position.
